(19) United States
(12) Patent Application Publication
(10) Pub. No.: US 2025/0274941 A1
(43) Pub. Date: Aug. 28, 2025

(54) METHODS AND SYSTEMS FOR CONDITIONAL PUSCH SKIPPING AND PUSCH REPETITIONS CONFIGURATION AT A USER EQUIPMENT

(71) Applicant: Apple Inc., Cupertino, CA (US)

(72) Inventors: Ralf Rossbach, Munich (DE); Murali Narasimha, Livermore, CA (US); Fangli Xu, Beijing (CN); Weidong Yang, San Diego, CA (US); Haijing Hu, Los Gatos, CA (US)

(21) Appl. No.: 18/858,615

(22) PCT Filed: May 7, 2022
(86) PCT No.: PCT/CN2022/091450

§ 371 Date: Oct. 21, 2024

(51) Int. Cl. H04W 72/21; H04B 17/318; H04W 24/08

(52) U.S. Cl. CPC H04W 72/21; H04B 17/318; H04W 24/08

(57) ABSTRACT

A user equipment (UE) includes a transceiver and a processor. The processor is configured to receive, from a base station and via the transceiver, configuration information including a number of radio conditions indicating when to suspend or resume conditional physical uplink shared channel (PUSCH) skipping. The processor is configured to evaluate whether at least one radio condition of the number of radio conditions is met and, in accordance with the at least one radio condition being met, enable or disable the conditional PUSCH skipping.

### TECHNICAL FIELD

This application relates generally to wireless communication systems, including methods and systems for configuring conditional physical uplink shared channel (PUSCH) skipping and PUSCH repetitions.

### BACKGROUND

Wireless mobile communication technology uses various standards and protocols to transmit data between a base station and a wireless communication device. Wireless communication system standards and protocols can include, for example, 3rd Generation Partnership Project (3GPP) long term evolution (LTE) (e.g., 4G), 3GPP new radio (NR) (e.g., 5G), and IEEE 802.11 standard for wireless local area networks (WLAN) (commonly known to industry groups as Wi-Fi®).

As contemplated by the 3GPP, different wireless communication systems standards and protocols can use various radio access networks (RANs) for communicating between a base station of the RAN (which may also sometimes be referred to generally as a RAN node, a network node, or simply a node) and a wireless communication device known as a user equipment (UE). 3GPP RANS can include, for example, global system for mobile communications (GSM), enhanced data rates for GSM evolution (EDGE) RAN (GERAN), Universal Terrestrial Radio Access Network (UTRAN), Evolved Universal Terrestrial Radio Access Network (E-UTRAN), and/or Next-Generation Radio Access Network (NG-RAN).

Each RAN may use one or more radio access technologies (RATs) to perform communication between the base station and the UE. For example, the GERAN implements GSM and/or EDGE RAT, the UTRAN implements universal mobile telecommunication system (UMTS) RAT or other 3GPP RAT, the E-UTRAN implements LTE RAT (sometimes simply referred to as LTE), and NG-RAN implements NR RAT (sometimes referred to herein as 5G RAT, 5G NR RAT, or simply NR). In certain deployments, the E-UTRAN may also implement NR RAT. In certain deployments, NG-RAN may also implement LTE RAT.

A base station used by a RAN may correspond to that RAN. One example of an E-UTRAN base station is an Evolved Universal Terrestrial Radio Access Network (E-UTRAN) Node B (also commonly denoted as evolved Node B, enhanced Node B, eNodeB, or eNB). One example of an NG-RAN base station is a next generation Node B (also sometimes referred to as a g Node B or gNB).

A RAN provides its communication services with external entities through its connection to a core network (CN). For example, E-UTRAN may utilize an Evolved Packet Core (EPC), while NG-RAN may utilize a 5G Core Network (5GC).

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 shows an example wireless communication system, according to embodiments described herein.

FIG. 2 illustrates an example flow-chart of operations being performed by a user equipment (UE), according to embodiments described herein.

FIG. 3 illustrates an example flow-chart of operations being performed by a base station, according to embodiments described herein.

FIG. 4 illustrates another example flow-chart of operations being performed by a UE, according to embodiments described herein.

FIG. 5 illustrates an example flow-chart of configuring a UE for conditional PUSCH skipping, and suspending and/or resuming the conditional PUSCH skipping, according to embodiments described herein.

FIG. 6 illustrates an example architecture of a wireless communication system, according to embodiments disclosed herein.

FIG. 7 illustrates a system for performing signaling between a wireless device and a network device, according to embodiments disclosed herein.

### DETAILED DESCRIPTION

In the present disclosure, various embodiments are related to conditional physical uplink shared channel (PUSCH) skipping (e.g., uplink (UL) skipping) and PUSCH repetitions (e.g., transport block (TB) repetitions) based on various criteria. Currently in 3GPP release 16, PUSCH skipping and PUSCH repetitions are not allowed to be configured together (i.e., active at the same time) at a user equipment (UE).

For example, following the conclusion in RAN1#105e, PUSCH skipping that includes both enhancedSkipUplinkTxDynamic-r16 and enhancedSkipUplink TxConfigured-r16, and PUSCH repetitions that include both type A and type B repetitions of PUSCH, cannot be configured together or is not expected to be configured together when a logical channel (LCH) based prioritization is not configured and there is a single physical layer (PHY) priority for UL transmissions.

Further, a time domain resource allocation (TDRA) list may be configured for both dynamic grant (DG) based PUSCH (DG PUSCH) transmission and configured grant (CG) based PUSCH (CG PUSCH) transmission with PUSCH repetitions with numberOfRepetitions (or a corresponding REPETITION_NUMBER per 3GPP Technical Specification (TS) 38.321 § 214) having a value greater than 1. Further, a UE may be configured with a TDRA list in which DG PUSCH transmission may be configured for PUSCH repetitions while not configuring the DG PUSCH transmission for DG PUSCH skipping, and vice versa. Similarly, a UE may be configured with a TDRA list in which CG PUSCH transmission may be configured for PUSCH skipping while not configuring the CG PUSCH transmission for CG PUSCH repetitions, and vice versa. However, both DG PUSCH and CG PUSCH cannot be configured for PUSCH repetitions and PUSCH skipping to work together. Additionally or alternatively, the TDRA list may be configured with an entry for PUSCH repetitions with numberOfRepetitions (or a corresponding REPETITION_NUMBER per 3GPP TS 38.331) having a value of 1 while Rel-16 CG or DG PUSCH skipping is active.

When a UE is in a cell edge area, radio signal quality may be poor and may cause a TB to be transmitted more than one time, to receive an acknowledgment from a base station that the TB has been successfully received by the base station. However, if a UE is configured for PUSCH skipping alone without PUSCH repetitions, it may result in degraded performance in the cell edge area because a TB that is lost in transmission due to poor signal quality in the cell edge area would not be retransmitted or not be transmitted with repetition.

In addition, poor radio signal quality in the cell edge area may also cause a base station to falsely detect PUSCH transmission from a UE, or not detect PUSCH transmission when transmitted from a UE. For example, a UE may have skipped PUSCH transmission (or UL transmission) such as discontinuous transmission (DTX), but a base station may detect PUSCH transmission, and the base station may transmit hybrid automatic repeat request negative acknowledgement (HARQ-NACK). The base station may falsely detect UL transmission in the cell edge area most likely because of the signal noise level for the UE in the cell edge area.

In some cases, a UE may transmit in a UL direction, but a base station may not detect the UL transmission. Accordingly, the base station may not transmit HARQ-NACK to the UE. In the absence of HARQ-NACK from the base station, the UE may assume that the TB was correctly received by the base station, for example, for UL transmission that is DG based.

Thus, UL transmission in a cell edge area may benefit from UL repetitions, but if UL skipping is configured and/or enabled, UL repetitions cannot be enabled and/or configured. This is an issue with UE configurations that could use improvement.

Accordingly, various embodiments described herein provide solutions in which both PUSCH skipping and PUSCH repetitions can be configured (but not used) together for a UE. A UE can send an indication when the UE has suspended or resumed PUSCH skipping and/or PUSCH repetitions. Accordingly, having both PUSCH skipping and PUSCH repetitions configured together for a UE, the UE may not have to rely on the network to disable PUSCH skipping via additional signaling from a network, or disable PUSCH skipping on time.

Reference will now be made in detail to representative embodiments/aspects illustrated in the accompanying drawings. It should be understood that the following description is not intended to limit the embodiments to one preferred embodiment. On the contrary, it is intended to cover alternatives, combinations, modifications, and equivalents as can be included within the spirit and scope of the described embodiments as defined by the appended claims.

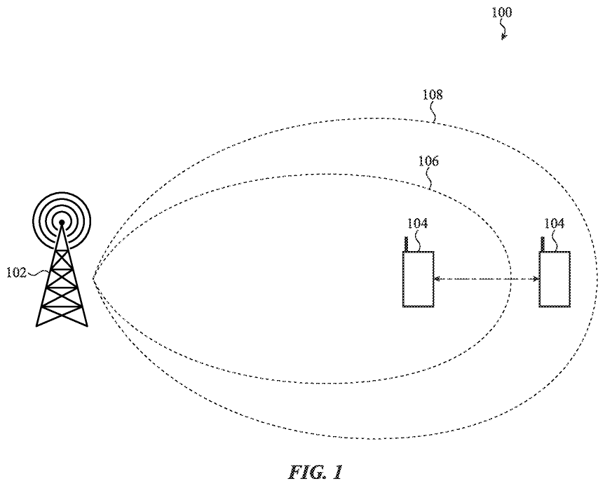

FIG. 1 shows an example wireless communication system, according to embodiments described herein. As shown in FIG. 1, a wireless communication system 100 may include a base station 102 that is communicatively coupled with a user equipment (UE) 104. In some embodiments, the base station 102 may be an eNb, an eNodeB, a gNodeB, or an access point (AP) in a radio access network (RAN) and may support one or more radio access technologies, such as 4G, 5G new radio (5G NR), and so on. The UE 104 may be a phone, a smart phone, a tablet, a smartwatch, an Internet-of-Things (IoT), and so on. The UE 104 may move within a cell area coverage of the base station 102, and/or may also move outside the cell area coverage of the base station 102.

In some embodiments, and by way of a non-limiting example, when the UE 104 is closer to the base station 102, e.g., within an area marked as 106, signal quality as measured at the UE 104 may be higher in comparison with signal quality as measured at the UE 104 when the UE 104 is in an area that is outside of the area marked as 106 but still within a cell coverage area of the base station 102 marked as 108. Accordingly, when the UE 104 is within the cell coverage area of the base station 102 marked as 108, but outside the area marked as 106, signal noise may increase the possibility and number of times false positive UL transmissions are detected at the base station 102, and may increase the possibility and number of times false negative UL transmissions are detected at the base station 102.

As described herein, UL repetition may be helpful to reduce the possibility and number of times false positive UL transmissions are detected at the base station 102. However, UL repetition is not allowed to be configured with UL skipping under currently proposed 3GPP standards 3GPP TS 38.331 and TS 38.321. A false positive UL transmission being detected at the base station 102 means that the base station detects a UL transmission when the UE has not transmitted anything to the base station, for example, in accord with a configured grant. Similarly, a false negative UL transmission being detected at the base station 102 means that the UE has transmitted a TB to the base station, but the TB is not received or not detected by the base station 102.

In some embodiments, and by way of a non-limiting example, a UE may be configured to report channel state information (CSI). CSI may include a channel quality indicator (CQI), precoding matrix indicator (PMI), CSI-RS resource indicator (CRI), synchronization signal/physical broadcast channel (SS/PBCH) block resource indicator (SSBRI), layer indicator (LI), rank indicator (RI), layer-1 reference signal received power (L1-RSRP), layer-1 signal-to-interference-and-noise ratio (L1-SINR), and/or CapabilityIndex, and a set of one or more trigger states. The set of one or more trigger states may include a list of associated CSI-ReportConfigs indicating resource set identifiers (IDs) for channel, and/or interference.

In some embodiments, a CSI reporting setting for the UE may be configured by a network and/or a base station using CSI-ReportConfig for channel measurement and/or interference measurement. The CSI-ReportConfig may include one or more parameters for a CSI reporting band. In some cases, the CSI-ReportConfig may also include, but is not limited to, a codebook configuration including a codebook subset restriction, time-domain behavior, frequency granularity for channel quality indicator (CQI) and/or precoding matrix indicator (PMI), and/or measurement restriction configurations, and so on.

In some embodiments, and by way of a non-limiting example, the CSI-ReportConfig may also include CSI-related quantities to be reported by the UE. For example, a UE may be configured with a CSI-ReportConfig with the higher layer parameter reportQuantity set to “cri-RI-PMI-CQI,” “cri-RI-i1,” “cri-RI-i1-CQI,” “cri-RI-CQI,” “cri-RSRP,” “cri-SINR,” “ssb-Index-RSRP,” “ssb-Index-SINR,” “cri-RI-LI-PMI-CQI,” “cri-RSRP-CapabilityIndex,” “ssb-Index-RSRP-CapabilityIndex,” “cri-SINR-CapabilityIndex,” and/or “ssb-Index-SINR-CapabilityIndex,” and so on.

In some embodiments, and by way of a non-limiting example, CSI resource settings for channel and interference measurement may include a CSI-IM resource for interference measurement, NZP CSI-RS resource for channel and/or interference measurement, and so on.

In some embodiments, and by way of a non-limiting example, CSI-MeasConfig may be used to configure CSI-RS (reference signals) corresponding to a cell area of a base station, and a UE may report channel state information on a physical uplink control channel (PUCCH) and/or PUSCH based on CSI-MeasConfig and/or DCI received at the UE from the base station. The UE may also transmit CSI corresponding interference measurement (CSI-IM) to the base station.

Accordingly, a number of CSI reports reported in uplink control information (UCI) or measurement reports corresponding to RRC configured measurements, CSI or CQI, and/or IM may be received at a base station from a number of UEs. By way of a non-limiting example, the number of measurement reports or CSI reports may be analyzed by the base station. Based on analysis of the number of measurement reports or CSI reports received from a UE or a number of UEs, a number of conditions, for example, radio conditions, may be identified in which conditional PUSCH skipping and/or PUSCH repetitions may be beneficial.

Accordingly, in some embodiments, and by way of a non-limiting example, a core network and/or a base station may configure a UE with boundary conditions, for example, radio conditions and/or other situations, in which the UE may be allowed to suspend (or disable) UL skipping and resume (or enable) UL repetition, or resume (or enable) UL skipping and suspend (or disable) UL repetition. Since the UE measures and tracks radio signal conditions, the UE may be configured to suspend and/or resume UL skipping and/or UL repetition based on radio signal conditions.

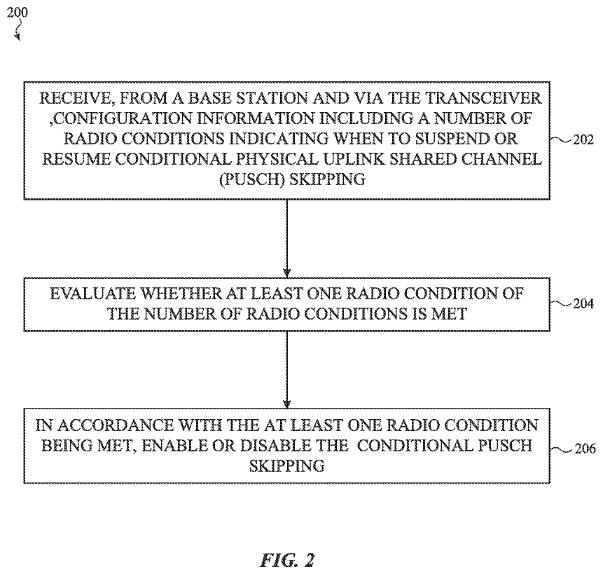

FIG. 2 illustrates an example flow-chart of operations being performed by a user equipment (UE), according to embodiments described herein. As shown in a flow-chart 200 of FIG. 2, at 202, a UE (e.g., the UE 104) may receive from a base station (e.g., the base station 102) configuration information including a number of radio conditions indicating when to suspend or resume conditional PUSCH skipping (or UL skipping) and/or PUSCH repetitions (or UL repetitions). As described herein, a UE may report radio conditions to a base station on a regular basis. Further, as described herein, network efficiency may be improved when UL repetition is enabled while a UE is in a cell edge area, where radio signal quality may be poor when compared with radio signal quality when the UE is close to the base station. Further, UL skipping and UL repetitions are not allowed to be configured together. However, as described herein, in accordance with some embodiments, a base station may configure the UE to resume UL skipping and suspend UL repetition, or suspend UL skipping and resume UL repetition based on a particular radio condition at the UE.

In some embodiments, and by way of a non-limiting example, the UE may be configured with a number of radio conditions in which UL skipping, when performed by a UE, may be valid. In some embodiments, the radio conditions may be presented based on location of a UE in a cell coverage area of a base station. Accordingly, when a UE may be determined to be away from a base station by at least a certain distance or cell radius, the UE may validly suspend UL skipping and resume UL repetition.

Accordingly, in some embodiments, at 204, the UE may evaluate whether at least one radio condition of the number of radio conditions associated with resuming UL skipping and suspending UL repetition, or suspending UL skipping and resuming UL repetition is met or not. In some embodiments, and by way of a non-limiting example, the UE may evaluate radio conditions over a period of time. In some cases, the period of time may be configured by the core network and/or the base station. In some cases, the period of time may be selected by the UE. In some cases, the UE may be configured with a set of trigger conditions to perform measurement to evaluate at least one radio condition of the number of radio conditions. The UE may perform measurement for evaluating and reporting at least one radio condition of the number of radio conditions using RRC signaling and/or L1 based CSI measurements.

In some embodiments, and by way of a non-limiting example, the number of radio conditions for evaluation by the UE may include measurement corresponding to RSRP, RSRQ, SINR, and/or interference over a specific time window. In some cases, the number of radio conditions for evaluation may be provided as conditional events and/or execution conditions. In other words, when the UE measurement corresponding to RSRP, RSRQ, SINR, and/or interference may reach a particular level, the UE may need to perform additional measurements. The additional measurements may be required to be performed over the specific time window.

In some embodiments, the number of radio conditions that are required to be evaluated by the UE may be configured in CSI-ReportConfig. In some examples, the number of radio conditions may include a set of conditional report quantities and CSI trigger states. A new field may be introduced in the CSI-ReportConfig for the set of conditional report quantities and CSI trigger states. As described herein, in some embodiments, the set of conditional report quantities may identify measurements to be performed by a UE. The measurements to be performed by the UE may include CSI-related measurements and/or L1-RSRP-related measurements. CSI-ReportConfig may thus identify CSI trigger states corresponding to each measurement that needs to be performed by the UE.

In some embodiments, the number of radio conditions that are required to be evaluated by the UE may be provided as additional offset values and/or conditions corresponding to RSRP, RSRQ, SINR, and/or interference measurements for the UE to perform UL skipping (or enable/resume UL skipping). In some cases, the additional offset values and/or conditions may be provided using RRC signaling, for example, in an RRC reconfiguration message. By way of a non-limiting example, in some embodiments, the configuration used for conditional handover (CHO) in the RRC reconfiguration message may be used for conditional UL skipping as well.

In some embodiments, the additional offset values for conditional UL skipping may be applicable when the UE is in a cell edge area, in which UL skipping may be suspended or disabled by the UE. In some embodiments, the additional offset values for conditional UL skipping may be provided to the UE as part of RRC condTriggerConfig and/or RRC condExecutionConfig, and/or a particular time for triggering UL skipping in relation to the additional offset values.

In some embodiments, the additional offset values may be provided as specifically dedicated or corresponding to the conditional UL skipping, as separate from conditional handover.

In some embodiments, the number of radio conditions that are to be evaluated by the UE for suspending UL skipping (resuming UL repetition) or resuming UL skipping (suspending UL repetition) may be configured to be separated for dynamic grant (DG) based UL transmission and configured grant (CG) based UL transmission. Further, the radio condition for suspending UL skipping may be different from resuming UL skipping.

In some embodiments, and by way of a non-limiting example, the number of radio conditions for suspending or resuming UL skipping may be configured as clearly defined or absolute threshold values. Accordingly, if a UE determines that the UE is outside a configured threshold value range, the UE may suspend UL skipping. And, when the UE determines that the UE is again within the configured threshold value range, the UE may enable UL skipping.

However, in some embodiments, the UE may be provided or configured to suspend or resume UL skipping (resume or suspend UL repetition) based on interference measurements and/or RSRP, RSRQ, and/or SINR measurement suggesting a change by a certain value. For example, the UE may be provisioned when CSI-IM measurements exceed by a particular set limit, the UE may suspend UL skipping. As the UE approaches the cell edge area, the interference level increases. Accordingly, the UE may be provisioned to measure CSI-IM measurements and determine if the interference level exceeds by a certain value for suspending UL skipping (or resuming UL repetition).

In some embodiments, when RSRP, RSRQ, and/or SINR measurement values change by a certain set amount since receiving an RRC reconfiguration message at a UE, the UE may suspend/resume UL skipping (resume/suspend UL repetition). Accordingly, a particular value corresponding to RSRP, RSRQ, and/or SINR at which the base station may have false positive or false negative detection of UL transmission may not be required to be disclosed to the UE. The certain set amount corresponding to RSRP, RSRQ, and/or SINR measurement value changes for suspending/resuming UL skipping may be communicated to the UE using the RRC reconfiguration message or MAC CE, such as DL MAC CE.

In some embodiments, the number of radio conditions indicating when to suspend or resume conditional UL skipping (resume or suspend conditional UL repetition) may be received using any of RRC signaling, downlink control information (DCI), MAC CE, and/or CSI-ReportConfig.

In some embodiments, at 206, a UE, upon performing measurements to determine at least one radio condition of the number of radio connections corresponding to suspending or resuming UL skipping (resuming or suspending UL repetition) has been met, the UE may suspend or resume UL skipping (resume or suspend UL repetition). In some cases, the at least one radio condition corresponding to suspending or resuming UL skipping (resuming or suspending UL repetition) may be required to meet at least a specific number of times and/or reported to the base station or core network, via UCI or CSI reporting and/or layer-3 measurements, at least a specific number of times before the UE can suspend or resume UL skipping (resume or suspend UL repetition).

In some cases, the UE may autonomously suspend or resume UL skipping (resume or suspend UL repetition) without sending an indication regarding suspension or resumption of UL skipping (or UL repetition). In some cases, the UE may send an indication to a base station serving the UE whenever the UE suspends or resumes UL skipping (or resumes or suspends UL repetition). By way of a non-limiting example, the UE may send the indication using MAC CE, MAC packet data unit (MAC PDU), or uplink control information (UCI).

As described herein, the UE may move in the cell area of the base station and radio conditions corresponding to suspending or resuming UL skipping may change, according to a time period between suspending UL skipping and resuming UL skipping may vary. If the time period between suspending UL skipping and resuming UL skipping is very short, for example, like almost immediately suspending UL skipping after resuming UL skipping, or vice versa, the base station may be unable to comprehend the UE's actions correctly. Further, the core network and/or base station may need processing time for the indication received regarding suspending or resuming UL skipping (resuming or suspending UL repetition).

Accordingly, in some embodiments, when the UE needs to suspend UL skipping after resuming UL skipping (or vice versa) in a very short time period subsequently, for example, like almost immediately, the UE may apply toggling of UL skipping (or UL repetition) after a specified time. In some embodiments, and by way of a non-limiting example, the specified time period may be a guard period, which is a certain number of slots following transmission of the indication to the base station using MAC CE or UCI, as described herein.

In some embodiments, and by way of a non-limiting example, the UE may send an indication that the UE is suspending or resuming UL skipping, and wait for an ACK or a NACK from the base station and/or the core network before changing UL skipping operation. In some embodiments, the UE may wait for a specific time period, which may be a guard period that corresponds to a certain number of slots following transmission of the indication to the base station using MAC CE or UCI, as described herein.

In some embodiments, and by way of a non-limiting example, the specified time period may be a timer or counter set to a particular value. The timer or counter may be set according to an estimated processing time required for the base station and/or the UE to process and/or acknowledge the indication sent using UCI or MAC CE, as described herein.

In some embodiments, and by way of a non-limiting example, the timer or counter may be related to control aging of CSI or measurement reporting information, e.g., time required to evaluate conditions as to whether UL skipping suspension or resumption is according to the configuration for UL skipping suspension or resumption. In some cases, the specified time period may correspond with the next UL grant. The next UL grant may be after the UE has received an acknowledgement for the indication sent to the base station using UCI or MAC CE, as described herein. In some cases, the next UL grant may be approximately determined based on an assumption when the base station may have received the indication sent to the base station using UCI or MAC CE, as described herein.

Accordingly, as described herein, a UE may be allowed to toggle UL skipping (or UL repetition) based on CSI and/or L3 measurement reporting. In some embodiments, a MAC layer of the UE may get a message or indication based on the performed L1 or L3 measurements that a criterion for toggling UL skipping (or UL repetition) is met. The MAC layer may then execute or perform algorithms related to UL skipping (or UL repetition).

In some embodiments, the information regarding suspending or resuming UL skipping may be sent using one or more bits of UCI or MAC CE. In carrier aggregation mode, at least one bit of UCI or MAC CE may be used to transmit an indication corresponding to a carrier. In some cases of carrier aggregation mode, at least one bit of UCI or MAC CE may be used for each serving cell to transmit an indication to the base station or core network. For example, different bit positions in a bitmap may relate to different serving cells when multiple CCs are combined in one direction.

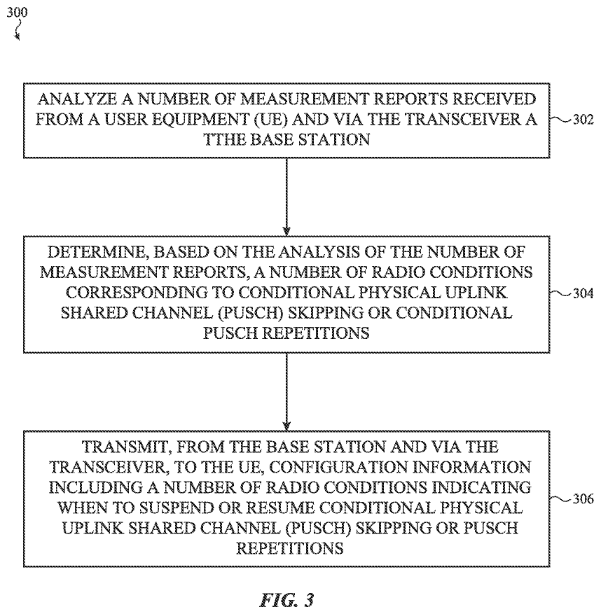

FIG. 3 illustrates an example flow-chart of operations being performed by a base station, according to embodiments described herein. As shown in a flow-chart 300 of FIG. 3, at 302, a base station and/or a core network may receive and analyze a number of measurement reports from one or more UEs. The number of measurement reports received from the one or more UEs may include different types of measurement reports such as L1 measurement reports, L3 measurement reports, interference measurement reports, CSI reports sent in UCI, and so on.

Based on the analysis of the number of measurement reports received from the one or more UEs, at 304, the base station and/or the core network may determine a number of radio conditions corresponding to conditional PUSCH skipping (or UL skipping) and/or PUSCH repetitions (or UL repetitions). As described herein, in accordance with some embodiments, various radio conditions corresponding to conditional UL skipping (or UL repetition) may be determined based on an evaluation of a signal-based condition (or a location) of a UE in a cell coverage area of a base station, such that when a UE determines that the UE is away from the base station by at least a certain distance or cell radius, the UE may validly suspend UL skipping and resume UL repetition.

In some embodiments, and by way of a non-limiting example, at least one radio condition of the number radio conditions associated with conditional UL skipping (or UL repetition) may include measurement(s) corresponding to RSRP, RSRQ, SINR, and/or interference over a specific time window. In some cases, the number of radio conditions may be conditional events and/or execution conditions, such that when the UE measurement corresponding to RSRP, RSRQ, SINR, and/or interference reaches a particular level, the UE may need to perform additional measurements. The additional measurements may be performed by the UE over a specific time window.

In some embodiments, the number of radio conditions may include additional offset values and/or conditions corresponding to RSRP, RSRQ, SINR, and/or interference measurements for the UE to perform UL skipping (or enable/resume UL skipping), as described herein.

In some embodiments, the number of radio conditions for conditional UL skipping (or UL repetition) may be separate for dynamic grant (DG) based UL transmission and configured grant (CG) based UL transmission. Further, the radio condition for suspending UL skipping may be different from resuming UL skipping.

In some embodiments, and by way of a non-limiting example, the number of radio conditions for suspending or resuming UL skipping may be absolute threshold values. However, in some embodiments, the number of radio conditions may be based on interference measurements and/or RSRP, RSRQ, and/or SINR measurement suggesting a change by a certain value, as described herein.

Upon determining the number of radio conditions corresponding to the conditional UL skipping (or UL repetition), the base station, at 306, may transmit configuration information including the number of radio conditions determined at 304, to a UE. The configuration information may be transmitted to the UE using RRC signaling (e.g., RRC reconfiguration), MAC CE, DCI, CSI-MeasConfig, and/or CSI-ReportConfig.

Accordingly, in some embodiments, the base station or core network may enable or disable UL skipping (or UL repetition) by transmitting radio condition configuration for conditional UL skipping to the UE. However, when the radio condition configuration is transmitted by DCI, it may have advantages over other methods, such as MAC CE. Further, transmitting the radio condition configuration using physical downlink control channel (PDCCH) may be preferred over transmitting the radio condition configuration using physical downlink shared channel (PDSCH) since loss of a signal is less likely.

In some embodiments, and by way of a non-limiting example, the radio condition configuration for conditional UL skipping (or UL repetition) may be suggested to be applied from next UL grant onwards, or after a configurable or predetermined amount of lead time or number of UL grants.

In some embodiments, and by way of a non-limiting example, the radio condition configuration for conditional UL skipping transmitted to a UE using MAC CE may be applied from the next UL grant after expiration of a timer that is started by the core network or the base station.

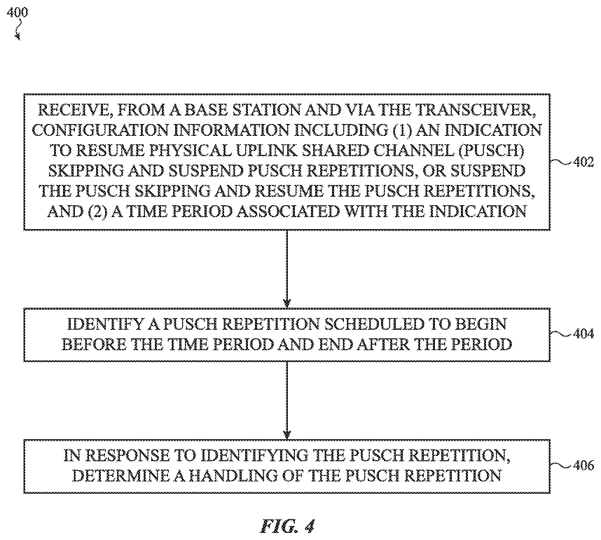

FIG. 4 illustrates another example flow-chart of operations being performed by a UE, according to embodiments described herein. As shown in a flow-chart 400 of FIG. 4, at 402, a UE may receive, from a base station, configuration information including an indication, for example, to resume or suspend UL skipping (suspend or resume UL repetition) and a time at which the UE needs to resume or suspend UL skipping. As described herein, the configuration information may be received by the UE using any of RRC signaling, DCI, or MAC CE, and so on, and, therefore, not repeated here again for brevity. In some embodiments, the UE may not receive another configuration information to suspend or resume UL skipping for a specific time period, such as a guard period.

At 404, the UE may identify a PUSCH repetitions (or UL repetition) that is scheduled to begin before applying the configuration information received at 402 and end after the time at which the UE needs to apply the configuration information. At 406, in response to identifying such PUSCH repetitions at 404, the UE may determine how to handle the PUSCH repetitions identified at 404 to avoid a situation in which UL skipping and UL repetition are used in parallel. In some cases, the UE may determine to delay UL repetition and/or UL skipping.

In some embodiments, the UE may also receive configuration information from the base station in which a number of radio conditions may be identified for conditional UL skipping (or UL repetition). However, the UE may give higher priority for conditional UL skipping that is based on an indication, received from the base station at 402, to apply conditional UL skipping at a particular time period. In some cases, the UE may give lower priority to conditional UL skipping that is based on an indication, received from the base station at 402, over conditional UL skipping based on meeting at least one radio condition of the number of radio conditions as received from the base station or core network, as described herein, in accordance with some embodiments.

In some embodiments, and by way of a non-limiting example, the configuration information for conditional UL skipping (or UL repetition) may be applicable to an entire MAC entity. In some embodiments, the configuration information for conditional UL skipping (or UL repetition) may be on a per component carrier (CC) and/or a per cell group basis (e.g., in new radio dual connectivity (NR-DC)).

In some embodiments, and by way of a non-limiting example, UL skipping may be configured on a per CC basis, which in some cases may be on a per PUCCH CC basis. In some cases, link conditions may be different for different PUCCH CCs, and, therefore, PUCCH carrier switching may also be configured on a per PUCCH CC basis. Accordingly, a UE can get a grant on a CC where UL skipping is not enabled and perform TB or UL repetitions, and, thereby improving reliability in the cell edge area. Further, no RRC reconfiguration and/or MAC CE may be required for this case. For example, CC1 may be configured with UL skipping, and CC2 may be configured without UL skipping but with TB repetitions. As a result, a UE may get a grant, e.g., CG, on CC2 where UL skipping is not enabled but TB repetitions is enabled. By way of a non-limiting example, a CG for CC1 may be compatible with a CG for CC2. In other words, a CG for CC1 may have similar grant size, periodicity, and/or quality of service (QOS) characteristics as a CG for CC2. Further, a CG for CC1 and a CG for CC2 may be mapped to the same logical channel.

In some embodiments, and by way of a non-limiting example, the configuration information for conditional UL skipping (or UL repetition) may include a number of sets of configuredGrantConfigs. For example, a first set of the number of sets of configuredGrantConfigs may be applicable when a UE is closer to a base station in a cell serving area of the base station, and a second set of the number of sets of configuredGrantConfigs may be applicable when the UE is in the cell edge area of the cell serving area of the base station.

In some embodiments, and by way of a non-limiting example, each of the first and second sets of configuredGrantConfigs may have the same CG index, but different reliability and/or PHY parameters. In some cases, each of the first and second sets of configuredGrantConfigs may have a different CG index, and switching of the UL skipping and UL repetition together may be performed using CG activation/deactivation messages.

In some embodiments, and by way of a non-limiting example, configuredGrantConfig may include a property or a field corresponding to disabling UL skipping, which may be activated when a UE is in the cell edge area.

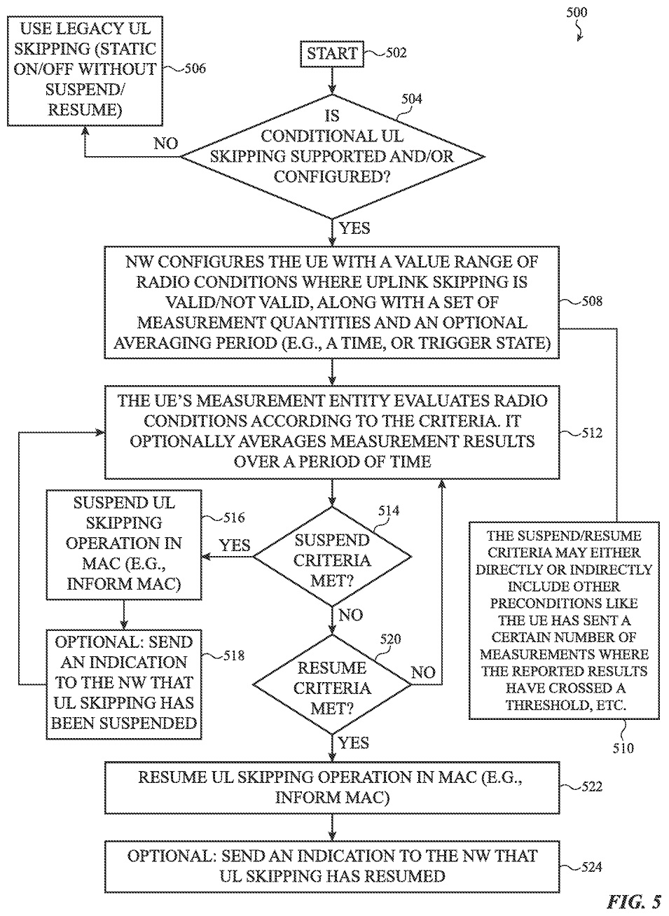

FIG. 5 illustrates an example flow-chart of configuring a UE for conditional PUSCH skipping, and suspending and/or resuming the conditional PUSCH skipping, according to embodiments described herein. As shown in a flow-chart 500 of FIG. 5, the flow-chart 500 begins at 502, and at 504, a core network and/or a base station may determine whether conditional UL skipping by a UE is supported and/or configured at the UE. For example, whether the UE supports conditional UL skipping may be mentioned by the UE using UE radio access capability information. Based on the received UE radio access capability information, if it is determined that the UE does not support conditional UL skipping, then the UE may be configured to use legacy UL skipping, in which UL skipping cannot be suspended and/or resumed, as described herein, in accordance with some embodiments.

However, at 504, based on the received UE radio access capability information, if it is determined that UE supports conditional UL skipping, at 508, the core network (CN or NW) and/or the base station may configure the UE with a value range of radio conditions identifying when UL skipping by the UE is valid and/or when UL skipping by the UE is invalid. Configuring the UE for conditional UL skipping is described in detail above, and, therefore, configuring the UE for conditional UE skipping is not being repeated here for brevity.

In some embodiments, as shown in FIG. 5 as 510, the configuration information (e.g., suspend/resume criteria for conditional UL skipping) transmitted to the UE may be either directly or indirectly based on a number of measurement reports previously sent to the base station and/or core network by the UE or a number of UEs.

At 512, the UE may perform measurements to evaluate radio conditions according to the criteria for conditional UL skipping as received from the core network and/or the base station at 508. The performed measurements and/or a specific criterion as received by the UE for conditional UL skipping (e.g., suspending UL skipping) may be checked at 514. If the criteria for suspending Ul skipping is found to be met, then at 516, the UE may suspend UL skipping, and may optionally send an indication to the base station and/or core network that the UE has suspended UL skipping, as shown in FIG. 5 as 518. The UE may continue to perform measurements, and thus may repeat step 512.

At 520, the UE may determine if criteria for resuming UL skipping is met or not based on the measurements performed at 512. If the measurements performed at 512 indicate that criteria for resuming UL skipping is not met, then the UE may continue to perform measurements, and thus may repeat step 512. However, if the measurements performed at 512 indicate that criteria for resuming UL skipping is met, the UE may resume UL skipping, as shown in FIG. 5 as 522. As shown in FIG. 5 as 524, the UE may also send an indication to the base station and/or core network that the UE has enabled UL skipping.

Various embodiments in the present disclosure describe conditional UL skipping and conditional UL repetition that is based on radio conditions at a UE. In some embodiments, conditional UL skipping and conditional UL repetition may be configured along with logical channel based prioritization (LCH-basedPrioritization) based on a new radio access capability that is supported by both the UE and the base station/core network. In some embodiments, “normal” (e.g., the existing Rel-16 enhanced) UL skipping and “normal” UL repetition may be configured along with logical channel based prioritization (LCH-based prioritization) based on a new radio access capability that is supported by both the UE and the base station/core network.

In some embodiments, the UE may automatically disable UL skipping and enable UL repetition based on preconfigured radio quality threshold and configuration similar to conditional handover (CHO), and inform the core network and/or the base station whenever the UE automatically disables UL skipping or enables UL repetition via UCI and/or MAC CE.

Embodiments contemplated herein include an apparatus having means to perform one or more elements of the method 200, 300, or 400. In the context of method 200, or 400, this apparatus may be, for example, an apparatus of a UE (such as a wireless device 702 that is a UE, as described herein). In the context of method 300, this apparatus may be, for example, an apparatus of a base station (such as a network device 720 that is a base station, as described herein).

Embodiments contemplated herein include one or more non-transitory computer-readable media storing instructions to cause an electronic device, upon execution of the instructions by one or more processors of the electronic device, to perform one or more elements of the method 200, 300, or 400. In the context of method 200, or 400, this non-transitory computer-readable media may be, for example, a memory of a UE (such as a memory 706 of a wireless device 702 that is a UE, as described herein). In the context of method 300, this non-transitory computer-readable media may be, for example, a memory of a base station (such as a memory 724 of a network device 720 that is a base station, as described herein).

Embodiments contemplated herein include an apparatus having logic, modules, or circuitry to perform one or more elements of the method 200, 300, or 400. In the context of method 200, or 400, this apparatus may be, for example, an apparatus of a UE (such as a wireless device 702 that is a UE, as described herein). In the context of method 300, this apparatus may be, for example, an apparatus of a base station (such as a network device 720 that is a base station, as described herein).

Embodiments contemplated herein include an apparatus having one or more processors and one or more computer-readable media, using or storing instructions that, when executed by the one or more processors, cause the one or more processors to perform one or more elements of the method 200, 300, or 400. In the context of method 200, or 400, this apparatus may be, for example, an apparatus of a UE (such as a wireless device 702 that is a UE, as described herein). In the context of the method 300, this apparatus may be, for example, an apparatus of a base station (such as a network device 720 that is a base station, as described herein).

Embodiments contemplated herein include a signal as described in or related to one or more elements of the method 200, 300, or 400.

Embodiments contemplated herein include a computer program or computer program product having instructions, wherein execution of the program by a processor causes the processor to carry out one or more elements of the method 200, 300, or 400. In the context of method 200, or 400, the processor may be a processor of a UE (such as a processor(s) 704 of a wireless device 702 that is a UE, as described herein), and the instructions may be, for example, located in the processor and/or on a memory of the UE (such as a memory 706 of a wireless device 702 that is a UE, as described herein). In the context of method 300, the processor may be a processor of a base station (such as a processor(s) 722 of a network device 720 that is a base station, as described herein), and the instructions may be, for example, located in the processor and/or on a memory of the base station (such as a memory 724 of a network device 720 that is a base station, as described herein).

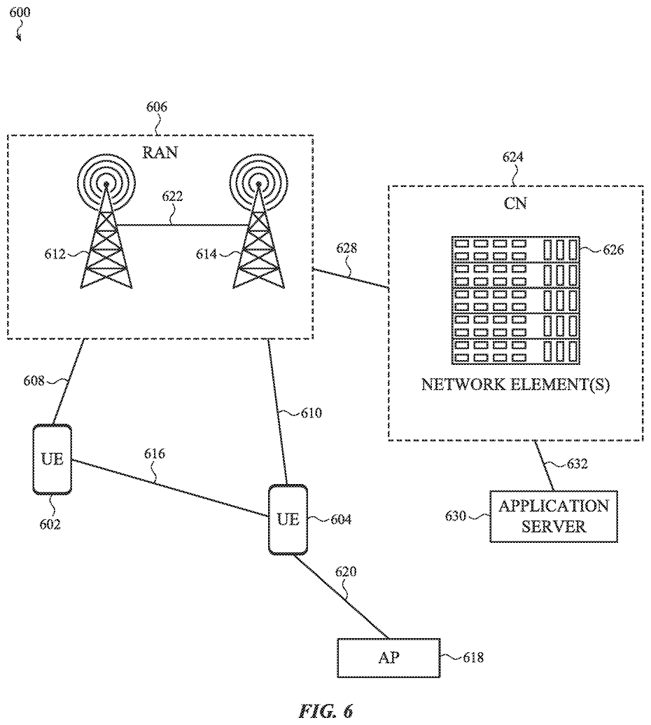

FIG. 6 illustrates an example architecture of a wireless communication system, according to embodiments disclosed herein. The following description is provided for an example wireless communication system 600 that operates in conjunction with the LTE system standards and/or 5G or NR system standards as provided by 3GPP technical specifications.

As shown by FIG. 6, the wireless communication system 600 includes UE 602 and UE 604 (although any number of UEs may be used). In this example, the UE 602 and the UE 604 are illustrated as smartphones (e.g., handheld touchscreen mobile computing devices connectable to one or more cellular networks), but may also comprise any mobile or non-mobile computing device configured for wireless communication.

The UE 602 and UE 604 may be configured to communicatively couple with a RAN 606. In embodiments, the RAN 606 may be NG-RAN, E-UTRAN, etc. The UE 602 and UE 604 utilize connections (or channels) (shown as connection 608 and connection 610, respectively) with the RAN 606, each of which comprises a physical communications interface. The RAN 606 can include one or more base stations, such as base station 612 and base station 614, that enable the connection 608 and connection 610.

In this example, the connection 608 and connection 610 are air interfaces to enable such communicative coupling, and may be consistent with RAT(s) used by the RAN 606, such as, for example, an LTE and/or NR.

In some embodiments, the UE 602 and UE 604 may also directly exchange communication data via a sidelink interface 616. The UE 604 is shown to be configured to access an access point (shown as AP 618) via connection 620. By way of example, the connection 620 can comprise a local wireless connection, such as a connection consistent with any IEEE 802.11 protocol, wherein the AP 618 may comprise a Wi-Fi® router. In this example, the AP 618 may be connected to another network (for example, the Internet) without going through a CN 624.

In embodiments, the UE 602 and UE 604 can be configured to communicate using orthogonal frequency division multiplexing (OFDM) communication signals with each other or with the base station 612 and/or the base station 614 over a multicarrier communication channel in accordance with various communication techniques, such as, but not limited to, an orthogonal frequency division multiple access (OFDMA) communication technique (e.g., for downlink communications) or a single carrier frequency division multiple access (SC-FDMA) communication technique (e.g., for uplink and ProSe or sidelink communications), although the scope of the embodiments is not limited in this respect. The OFDM signals can comprise a plurality of orthogonal subcarriers.

In some embodiments, all or parts of the base station 612 or base station 614 may be implemented as one or more software entities running on server computers as part of a virtual network. In addition, or in other embodiments, the base station 612 or base station 614 may be configured to communicate with one another via interface 622. In embodiments where the wireless communication system 600 is an LTE system (e.g., when the CN 624 is an EPC), the interface 622 may be an X2 interface. The X2 interface may be defined between two or more base stations (e.g., two or more eNBs and the like) that connect to an EPC, and/or between two eNBs connecting to the EPC. In embodiments where the wireless communication system 600 is an NR system (e.g., when CN 624 is a 5GC), the interface 622 may be an Xn interface. The Xn interface is defined between two or more base stations (e.g., two or more gNBs and the like) that connect to 5GC, between a base station 612 (e.g., a gNB) connecting to 5GC and an eNB, and/or between two eNBs connecting to 5GC (e.g., CN 624).

The RAN 606 is shown to be communicatively coupled to the CN 624. The CN 624 may comprise one or more network elements 626, which are configured to offer various data and telecommunications services to customers/subscribers (e.g., users of UE 602 and UE 604) who are connected to the CN 624 via the RAN 606. The components of the CN 624 may be implemented in one physical device or separate physical devices including components to read and execute instructions from a machine-readable or computer-readable medium (e.g., a non-transitory machine-readable storage medium).

In embodiments, the CN 624 may be an EPC, and the RAN 606 may be connected with the CN 624 via an S1 interface 628. In embodiments, the S1 interface 628 may be split into two parts, an S1 user plane (S1-U) interface, which carries traffic data between the base station 612 or base station 614 and a serving gateway (S-GW), and the S1-MME interface, which is a signaling interface between the base station 612 or base station 614 and mobility management entities (MMEs).

In embodiments, the CN 624 may be a 5GC, and the RAN 606 may be connected with the CN 624 via an NG interface 628. In embodiments, the NG interface 628 may be split into two parts, an NG user plane (NG-U) interface, which carries traffic data between the base station 612 or base station 614 and a user plane function (UPF), and the S1 control plane (NG-C) interface, which is a signaling interface between the base station 612 or base station 614 and access and mobility management functions (AMFs).

Generally, an application server 630 may be an element offering applications that use internet protocol (IP) bearer resources with the CN 624 (e.g., packet switched data services). The application server 630 can also be configured to support one or more communication services (e.g., VOIP sessions, group communication sessions, etc.) for the UE 602 and UE 604 via the CN 624. The application server 630 may communicate with the CN 624 through an IP communications interface 632.

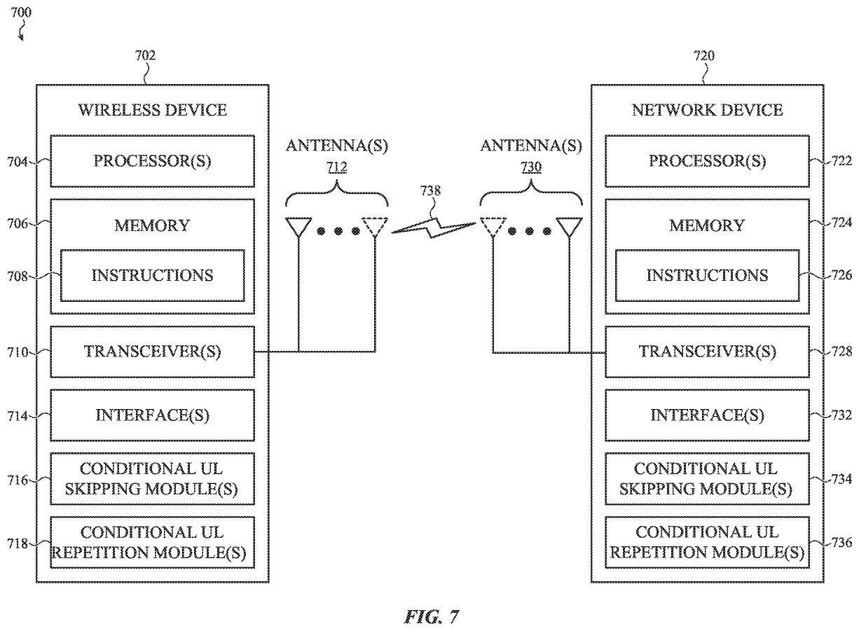

FIG. 7 illustrates a system 700 for performing signaling 738 between a wireless device 702 and a network device 720, according to embodiments disclosed herein. The system 700 may be a portion of a wireless communications system as herein described. The wireless device 702 may be, for example, a UE of a wireless communication system. The network device 720 may be, for example, a base station (e.g., an eNB or a gNB) of a wireless communication system.

The wireless device 702 may include one or more processor(s) 704. The processor(s) 704 may execute instructions such that various operations of the wireless device 702 are performed, as described herein. The processor(s) 704 may include one or more baseband processors implemented using, for example, a central processing unit (CPU), a digital signal processor (DSP), an application specific integrated circuit (ASIC), a controller, a field programmable gate array (FPGA) device, another hardware device, a firmware device, or any combination thereof configured to perform the operations described herein.

The wireless device 702 may include a memory 706. The memory 706 may be a non-transitory computer-readable storage medium that stores instructions 708 (which may include, for example, the instructions being executed by the processor(s) 704). The instructions 708 may also be referred to as program code or a computer program. The memory 706 may also store data used by, and results computed by, the processor(s) 704.

The wireless device 702 may include one or more transceiver(s) 710 that may include radio frequency (RF) transmitter and/or receiver circuitry that use the antenna(s) 712 of the wireless device 702 to facilitate signaling (e.g., the signaling 738) to and/or from the wireless device 702 with other devices (e.g., the network device 720) according to corresponding RATs.

The wireless device 702 may include one or more antenna(s) 712 (e.g., one, two, four, or more). For embodiments with multiple antenna(s) 712, the wireless device 702 may leverage the spatial diversity of such multiple antenna(s) 712 to send and/or receive multiple different data streams on the same time and frequency resources. This behavior may be referred to as, for example, multiple input multiple output (MIMO) behavior (referring to the multiple antennas used at each of a transmitting device and a receiving device that enable this aspect). MIMO transmissions by the wireless device 702 may be accomplished according to precoding (or digital beamforming) that is applied at the wireless device 702 that multiplexes the data streams across the antenna(s) 712 according to known or assumed channel characteristics such that each data stream is received with an appropriate signal strength relative to other streams and at a desired location in the spatial domain (e.g., the location of a receiver associated with that data stream). Certain embodiments may use single user MIMO (SU-MIMO) methods (where the data streams are all directed to a single receiver) and/or multi user MIMO (MU-MIMO) methods (where individual data streams may be directed to individual (different) receivers in different locations in the spatial domain).

In certain embodiments having multiple antennas, the wireless device 702 may implement analog beamforming techniques, whereby phases of the signals sent by the antenna(s) 712 are relatively adjusted such that the (joint) transmission of the antenna(s) 712 can be directed (this is sometimes referred to as beam steering).

The wireless device 702 may include one or more interface(s) 714. The interface(s) 714 may be used to provide input to or output from the wireless device 702. For example, a wireless device 702 that is a UE may include interface(s) 714 such as microphones, speakers, a touchscreen, buttons, and the like in order to allow for input and/or output to the UE by a user of the UE. Other interfaces of such a UE may be made up of transmitters, receivers, and other circuitry (e.g., other than the transceiver(s) 710/antenna(s) 712 already described) that allow for communication between the UE and other devices and may operate according to known protocols (e.g., Wi-Fi®, Bluetooth®, and the like).

The wireless device 702 may include a conditional UL skipping module 716 and/or a conditional UL repetition module 718. The conditional UL skipping module 716 and conditional UL repetition module 718 may be implemented via hardware, software, or combinations thereof. For example, the conditional UL skipping module 716 and conditional UL repetition module 718 may be implemented as a processor, circuit, and/or instructions 708 stored in the memory 706 and executed by the processor(s) 704. In some examples, the conditional UL skipping module 716 and conditional UL repetition module 718 may be integrated within the processor(s) 704 and/or the transceiver(s) 710. For example, the conditional UL skipping module 716 and conditional UL repetition module 718 may be implemented by a combination of software components (e.g., executed by a DSP or a general processor) and hardware components (e.g., logic gates and circuitry) within the processor(s) 704 or the transceiver(s) 710.

The conditional UL skipping module 716 may be used for various aspects of the present disclosure, for example, aspects of FIGS. 1-5. The conditional UL skipping module 716 may be configured to, for example, enable or disable UL skipping based on one or more radio conditions detected at the wireless device 702.

The conditional UL repetition module 718 may be used for various aspects of the present disclosure, for example, aspects of FIGS. 1-5. The conditional UL repetition module 718 may be configured to, for example, enable or disable UL repetition based on one or more radio conditions detected at the wireless device 702.

The network device 720 may include one or more processor(s) 722. The processor(s) 722 may execute instructions such that various operations of the network device 720 are performed, as described herein. The processor(s) 722 may include one or more baseband processors implemented using, for example, a CPU, a DSP, an ASIC, a controller, an FPGA device, another hardware device, a firmware device, or any combination thereof configured to perform the operations described herein.

The network device 720 may include a memory 724. The memory 724 may be a non-transitory computer-readable storage medium that stores instructions 726 (which may include, for example, the instructions being executed by the processor(s) 722). The instructions 726 may also be referred to as program code or a computer program. The memory 724 may also store data used by, and results computed by, the processor(s) 722.

The network device 720 may include one or more transceiver(s) 728 that may include RF transmitter and/or receiver circuitry that use the antenna(s) 730 of the network device 720 to facilitate signaling (e.g., the signaling 738) to and/or from the network device 720 with other devices (e.g., the wireless device 702) according to corresponding RATs.

The network device 720 may include one or more antenna(s) 730 (e.g., one, two, four, or more). In embodiments having multiple antenna(s) 730, the network device 720 may perform MIMO, digital beamforming, analog beamforming, beam steering, etc., as has been described.

The network device 720 may include one or more interface(s) 732. The interface(s) 732 may be used to provide input to or output from the network device 720. For example, a network device 720 that is a base station may include interface(s) 732 made up of transmitters, receivers, and other circuitry (e.g., other than the transceiver(s) 728/antenna(s) 730 already described) that enables the base station to communicate with other equipment in a core network, and/or that enables the base station to communicate with external networks, computers, databases, and the like for purposes of operations, administration, and maintenance of the base station or other equipment operably connected thereto.

The network device 720 may include a conditional UL skipping module 734 and/or a conditional UL repetition module 736. The conditional UL skipping module 734 and conditional UL repetition module 736 may be implemented via hardware, software, or combinations thereof. For example, the conditional UL skipping module 734 and conditional UL repetition module 736 may be implemented as a processor, circuit, and/or instructions 726 stored in the memory 724 and executed by the processor(s) 722. In some examples, the conditional UL skipping module 734 and conditional UL repetition module 736 may be integrated within the processor(s) 722 and/or the transceiver(s) 728. For example, the conditional UL skipping module 734 and conditional UL repetition module 736 may be implemented by a combination of software components (e.g., executed by a DSP or a general processor) and hardware components (e.g., logic gates and circuitry) within the processor(s) 722 or the transceiver(s) 728.

The conditional UL skipping module 734 may be used for various aspects of the present disclosure, for example, aspects of FIGS. 1-5. The conditional UL skipping module 734 may be configured to, for example, enable or disable UL skipping based on one or more radio conditions detected at another device (e.g., the wireless device 702).

The conditional UL repetition module 736 may be used for various aspects of the present disclosure, for example, aspects of FIGS. 1-5. The conditional UL repetition module 736 may be configured to, for example, enable or disable UL repetition based on one or more radio conditions detected at another device (e.g., the wireless device 702).

For one or more embodiments, at least one of the components set forth in one or more of the preceding figures may be configured to perform one or more operations, techniques, processes, and/or methods as set forth herein. For example, a baseband processor as described herein in connection with one or more of the preceding figures may be configured to operate in accordance with one or more of the examples set forth herein. For another example, circuitry associated with a UE, base station, network element, etc. as described above in connection with one or more of the preceding figures may be configured to operate in accordance with one or more of the examples set forth herein.

Any of the above described embodiments may be combined with any other embodiment (or combination of embodiments), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Embodiments and implementations of the systems and methods described herein may include various operations, which may be embodied in machine-executable instructions to be executed by a computer system. A computer system may include one or more general-purpose or special-purpose computers (or other electronic devices). The computer system may include hardware components that include specific logic for performing the operations or may include a combination of hardware, software, and/or firmware.

It should be recognized that the systems described herein include descriptions of specific embodiments. These embodiments can be combined into single systems, partially combined into other systems, split into multiple systems or divided or combined in other ways. In addition, it is contemplated that parameters, attributes, aspects, etc. of one embodiment can be used in another embodiment. The parameters, attributes, aspects, etc. are merely described in one or more embodiments for clarity, and it is recognized that the parameters, attributes, aspects, etc. can be combined with or substituted for parameters, attributes, aspects, etc. of another embodiment unless specifically disclaimed herein.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Although the foregoing has been described in some detail for purposes of clarity, it will be apparent that certain changes and modifications may be made without departing from the principles thereof. It should be noted that there are many alternative ways of implementing both the processes and apparatuses described herein. Accordingly, the present embodiments are to be considered illustrative and not restrictive, and the description is not to be limited to the details given herein, but may be modified within the scope and equivalents of the appended claims.

1. A user equipment (UE), comprising:
a transceiver; and
a processor configured to:
receive, from a base station and via the transceiver, configuration information including a number of radio conditions indicating when to suspend or resume conditional physical uplink shared channel (PUSCH) skipping;
evaluate whether at least one radio condition of the number of radio conditions is met; and
in accordance with the at least one radio condition being met, enable or disable the conditional PUSCH skipping.

2. The UE of claim 1, wherein:
the configuration information further includes a number of radio conditions indicating when to suspend or resume conditional PUSCH repetitions; and
the processor is further configured to:
in accordance with the at least one radio condition being met, enable or disable the conditional PUSCH repetitions.

3. The UE of claim 1, wherein the processor is further configured to:
transmit, to the base station and via the transceiver, an indication of enabling or disabling of the conditional PUSCH skipping.

4. The UE of claim 3, wherein the indication is transmitted in uplink control information (UCI).

5. The UE of claim 3, wherein the indication is transmitted in a medium access control packet data unit (MAC PDU) or a medium access control control element (MAC CE).

6. The UE of claim 1, wherein:
the number of radio conditions include at least one of:
a predetermined threshold or a range of one or more radio signal quality measurements; or
a predetermined threshold or a range of one or more interference measurements; and
the predetermined threshold or the range of the one or more radio signal quality measurements or the predetermined threshold or the range of the one or more interference measurements are configured for a defined measurement window.

7. The UE of claim 6, wherein the number of radio conditions include an offset value for at least one of:
a reference signal received power (RSRP) measurement;
a reference signal received quality (RSRQ) measurement; or
a signal-to-interference-noise ratio (SINR) measurement.

8. The UE of claim 7, wherein at least one of the offset values is applicable to a cell edge area, the cell edge area identified based on a number of measurement reports received from a number of UEs.

9. The UE of claim 1, wherein the configuration information is received in radio resource control (RRC) signaling, a channel state information report configuration (CSI-ReportConfig), CSI-MeasConfig, downlink control information (DCI), or a medium access control control element (MAC CE).

10. The UE of claim 1, wherein the processor is configured to:
in response to the at least one radio condition being met, corresponding to enabling the conditional PUSCH skipping, wait for disabling the conditional PUSCH skipping in accord with a first criterion, or
in response to the at least one radio condition being met, corresponding to disabling the conditional PUSCH skipping, wait for enabling the conditional PUSCH skipping in accord with a second criterion.

11. The UE of claim 10, wherein the first criterion or the second criterion includes lapse of a guard period, the guard period having a predetermined timer value.

12. The UE of claim 1, wherein the configuration information further indicates when to suspend or resume logical channel based prioritization (LCH-basedPrioritization) of a PUSCH transmission.

13. The UE of claim 1, wherein:
the configuration information further includes a number of sets of configuredGrantConfigs; and
each set of the number of sets of configuredGrantConfigs corresponds to enabling or disabling the conditional PUSCH skipping based on a location of the UE in a cell area of the base station.

14. A base station, comprising:
a transceiver; and
a processor configured to:
analyze a number of measurement reports received from a user equipment (UE) and via the transceiver at the base station;
determine, based on the analysis of the number of measurement reports, a number of radio conditions corresponding to conditional physical uplink shared channel (PUSCH) skipping or conditional PUSCH repetitions; and
transmit, from the base station and via the transceiver, to the UE, configuration information including a number of radio conditions indicating when to suspend or resume conditional physical uplink shared channel (PUSCH) skipping or PUSCH repetitions.

15. The base station of claim 14, wherein the configuration information regarding suspending or resuming the conditional PUSCH skipping or PUSCH repetitions is configured on a per component carrier (CC) and per cell group basis.

16. The base station of claim 14, wherein the configuration information further includes a first set of configuredGrantConfigs and a second set of configuredGrantConfigs for enabling or disabling the conditional PUSCH skipping based on a location of the UE in a cell area of the base station.

17. The base station of claim 14, wherein:
the configuration information further includes a timer value, the timer value identifying when to suspend the conditional PUSCH skipping upon receiving the configuration at the UE in a downlink medium access control control element (DL MAC CE); and
the configuration information is transmitted to the UE in the DL MAC CE.

18. A user equipment (UE), comprising:
a transceiver; and
a processor configured to:
receive, from a base station and via the transceiver, configuration information including:
an indication to resume physical uplink shared channel (PUSCH) skipping and suspend PUSCH repetitions, or to suspend the PUSCH skipping and resume the PUSCH repetitions; and
a time period associated with the indication;
identify a PUSCH repetition scheduled to begin before the time period and end after the period; and
in response to identifying the PUSCH repetition, determine a handling of the PUSCH repetition.

19. The UE of claim 18, wherein:
the configuration information further includes a number of radio conditions indicating when to suspend or resume conditional physical uplink shared channel (PUSCH) skipping or PUSCH repetitions; and
suspending or resuming the conditional PUSCH skipping based on the indication from the base station having a higher priority over suspending or resuming the conditional PUSCH skipping based on at least one radio condition of the number of radio conditions being met.

20. The UE of claim 19, wherein the configuration information regarding when to suspend or resume the conditional PUSCH skipping or PUSCH repetitions is applicable to an entire MAC entity.
